(19) United States
(12) Patent Application Publication
(10) Pub. No.: US 2026/0133025 A1
(43) Pub. Date: May 14, 2026

(54) OPTICAL COHERENCE TOMOGRAPHIC IMAGING APPARATUS

(71) Applicant: TERUMO KABUSHIKI KAISHA, Tokyo (JP)

(72) Inventor: Ryo UEHARA, Hadano-shi (JP)

(73) Assignee: TERUMO KABUSHIKI KAISHA, Tokyo (JP)

(21) Appl. No.: 19/443,143

(22) Filed: Jan. 8, 2026

Related U.S. Application Data
(63) Continuation of application No. PCT/JP2024/023592, filed on Jun. 28, 2024.

(30) Foreign Application Priority Data
Jul. 11, 2023 (JP) 2023-114035

(51) Int. Cl. G01B 9/02055; G01B 9/02015; G01B 9/02091

(52) U.S. Cl. CPC G01B 9/02072; G01B 9/02027; G01B 9/02091

(57) ABSTRACT

An optical coherence tomographic imaging apparatus includes a light source that outputs output light while periodically changing a wavelength, a light splitter that splits the output light output from the light source into measurement light and reference light, a photoelectric converter that converts interference light obtained by interference between the reference light and reflected light of the measurement light with which an object to be measured is irradiated via a first optical path through which the measurement light is propagated from the light splitter to the object to be measured into an electric signal, a signal processing unit that performs arithmetic processing on the electric signal on the basis of a correction parameter stored in a storage unit to acquire a tomographic image of the object to be measured, and a switching unit provided in the first optical path that switches a propagation destination of the measurement light.

### CROSS-REFERENCES TO RELATED APPLICATIONS

This application is a continuation of International Application No. PCT/JP 2024/023592 filed on Jun. 28, 2024, which claims priority to Japanese Application No. 2023-114035 filed on Jul. 11, 2023, the entire content of both of which is incorporated herein by reference.

### TECHNOLOGICAL FIELD

The present disclosure relates to an optical coherence tomographic imaging apparatus.

### BACKGROUND DISCUSSION

Japanese Patent Application Publication No. 2011-206374 A discloses that in an optical image diagnosis apparatus, a parameter representing a characteristic unique to each unit is stored in an exchangeable unit, and unit information including the parameter is acquired from each unit at the time of operation control unit startup or in a case where a specific instruction is given.

However, a sweeping profile of the optical image diagnosis apparatus drifts due to repeated use, a change in temperature, long-term use and the like. Therefore, in a configuration in which calibration is performed using the parameter set in advance in the apparatus as in Japanese Patent Application Publication No. 2011-206374 A, the parameter could not be optimized according to the state of the apparatus. As a result, the conventional configuration has room for improvement in resolution of an obtained image.

### SUMMARY

The present disclosure enables acquisition of an image with relatively higher resolution.

According to the present disclosure, (1) an optical coherence tomographic imaging apparatus including a wavelength sweeping light source that outputs output light while periodically changing a wavelength; a light splitter that splits the output light output from the wavelength sweeping light source into measurement light and reference light; a photoelectric converter that converts light intensity of interference light obtained by interference between the reference light and reflected light of the measurement light with which an object to be measured is irradiated via a first optical path through which the measurement light is propagated from the light splitter to the object to be measured into an electric signal; a signal processing unit that performs arithmetic processing on the electric signal on the basis of a correction parameter stored in a storage unit to acquire a tomographic image of the object to be measured; and a switching unit provided in the first optical path that switches a propagation destination of the measurement light between the object to be measured and a second optical path provided with a reflector at one end of the switching unit, in which the signal processing unit updates the correction parameter stored in the storage unit on the basis of interference light obtained by interference between the reference light and reflected light of the measurement light with which the reflector is irradiated via the second optical path in a state in which the measurement light is propagated to the reflector via the second optical path.

(2 ) In the optical coherence tomographic imaging apparatus according to (1), the signal processing unit may acquire a parameter for canceling an influence of a nonlinear change of a wavelength of the output light output from the wavelength sweeping light source with respect to time on the basis of the interference light obtained by interference between the reference light and the reflected light of the measurement light with which the reflector is irradiated via the second optical path, and update the correction parameter stored in the storage unit with the acquired parameter.

(3) In the optical coherence tomographic imaging apparatus according to (1) or (2), the signal processing unit may acquire a parameter for canceling an influence of variation by a wavelength in propagation speeds of the measurement light propagated through the first optical path and the reference light on the basis of the interference light obtained by interference between the reference light and the reflected light of the measurement light with which the reflector is irradiated via the second optical path, and update the correction parameter stored in the storage unit with the acquired parameter.

(4) In the optical coherence tomographic imaging apparatus according to any one of (1) to (3), the switching unit may switch the propagation destination of the measurement light from the object to be measured to the second optical path on the

basis of an operation state of the optical coherence tomographic imaging apparatus, and the signal processing unit may update the correction parameter stored in the storage unit on the basis of the interference light obtained by interference between the reference light and the reflected light of the measurement light with which the reflector is irradiated in a state in which the measurement light is propagated to the reflector via the second optical path.

(5) In the optical coherence tomographic imaging apparatus according to (4), the switching unit may switch the propagation destination of the measurement light from the object to be measured to the second optical path in a case where it is detected that at least either temperature or an operation time of the optical coherence tomographic imaging apparatus satisfies a predetermined condition as the operation state.

(6) In the optical coherence tomographic imaging apparatus according to any one of (1) to (5), the switching unit may switch the propagation destination of the measurement light from the object to be measured to the second optical path in conjunction with a startup operation or a shutdown operation of the optical coherence tomographic imaging apparatus in a case where it is detected that at least either the temperature or operation time of the optical coherence tomographic imaging apparatus satisfies a predetermined condition.

According to the present disclosure, an optical coherence tomographic imaging apparatus is (7) an optical coherence tomographic imaging apparatus including: a wavelength sweeping light source that outputs output light while periodically changing a wavelength; a light splitter that splits the output light output from the wavelength sweeping light source into measurement light and reference light; a photoelectric converter that converts light intensity of interference light obtained by interference between the reference light and reflected light of the measurement light with which an object to be measured is irradiated via a first optical path through which the measurement light is propagated from the light splitter to the object to be measured into an electric signal; a signal processing unit that performs arithmetic processing on the electric signal on the basis of a correction parameter stored in a storage unit to acquire a tomographic image of the object to be measured; and an adjustment unit that adjusts an optical path length such that the photoelectric converter detects light intensity of interference light obtained by interference between the reference light and reflected light from a predetermined position determined in advance in the first optical path, in which the signal processing unit updates the correction parameter stored in the storage unit on the basis of the interference light obtained by interference between the reference light and the reflected light from the predetermined position.

(8) In the optical coherence tomographic imaging apparatus according to (7), the signal processing unit may update the correction parameter stored in the storage unit on the basis of the interference light obtained by interference between the reference light and reflected light from a position of a connection surface of different materials in the first optical path or a position of a crack of a material through which the measurement light is propagated in the first optical path as the predetermined position.

(9) In the optical coherence tomographic imaging apparatus according to (7) or (8), the signal processing unit may acquire a parameter for canceling an influence of a nonlinear change of a wavelength of the output light output from the wavelength sweeping light source with respect to time on the basis of the interference light obtained by interference between the reference light and the reflected light of the measurement light from the predetermined position, and update the correction parameter stored in the storage unit with the acquired parameter.

(10) In the optical coherence tomographic imaging apparatus according to any one of (7) to (9), the signal processing unit may acquire a parameter for canceling an influence of variation by a wavelength in propagation speeds of the measurement light propagated through the first optical path and the reference light on the basis of the interference light obtained by interference between the reference light and the reflected light of the measurement light from the predetermined position, and update the correction parameter stored in the storage unit with the acquired parameter.

(11) In the optical coherence tomographic imaging apparatus according to any one of (7) to (10), the adjustment unit may adjust an optical path length such that the photoelectric converter detects light intensity of the interference light obtained by interference between the reference light and the reflected light from the predetermined position on the basis of an operation state of the optical coherence tomographic imaging apparatus, and the signal processing unit may update the correction parameter stored in the storage unit on the basis of the interference light obtained by interference between the reference light and the reflected light from the predetermined position.

(12) In the optical coherence tomographic imaging apparatus according to (11), in a case where it is detected that at least either temperature or an operation time of the optical coherence tomographic imaging apparatus satisfies a predetermined condition as the operation state, the adjustment unit may adjust the optical path length such that the photoelectric converter detects light intensity of the interference light obtained by interference between the reference light and the reflected light from the predetermined position.

(13) In the optical coherence tomographic imaging apparatus according to any one of (7) to (12), in a case where it is detected that at least either temperature or an operation time of the optical coherence tomographic imaging apparatus satisfies a predetermined condition, the signal processing unit may adjust the optical path length such that the photoelectric converter detects light intensity of the interference light obtained by interference between the reference light and the reflected light from the predetermined position in conjunction with a startup operation or a shutdown operation of the optical coherence tomographic imaging apparatus.

(14) A method for improving resolution of an image with an optical coherence tomographic imaging apparatus, the method comprising: outputting an output light while periodically changing a wavelength with a wavelength sweeping light source; splitting the output light output from the wavelength sweeping light source into measurement light and reference light with a light splitter; converting light intensity of interference light obtained by interference between the reference light and reflected light of the measurement light with which an object to be measured is irradiated via a first optical path through which the measurement light is propagated from the light splitter to the object to be measured into an electric signal with a photoelectric converter; performing arithmetic processing on the electric signal on a basis of a correction parameter stored in a storage unit to acquire a tomographic image of the object to be measured with a signal processing unit; switching a propagation destination of the measurement light between the object to be measured with a switching unit provided in the first optical path, and a second optical path provided with a reflector at one end of the switching unit; and updating the correction parameter stored in the storage unit on a basis of interference light obtained by interference between the reference light and reflected light of the measurement light with which the reflector is irradiated via the second optical path in a state in which the measurement light is propagated to the reflector via the second optical path with the signal processing unit.

According to an embodiment of the present disclosure, an image with higher resolution can be acquired.

### BRIEF DESCRIPTION OF THE DRAWINGS

FIG. 1 is a diagram illustrating an example of an appearance of an imaging apparatus according to an embodiment.

FIG. 2 is a block diagram illustrating an example of a functional configuration of the imaging apparatus according to an embodiment.

FIG. 3 is a block diagram illustrating a configuration example of a signal processing unit and other functional elements in FIG. 2.

FIG. 4 is a block diagram illustrating a configuration example of a calibration unit in FIG. 2.

FIG. 5 is a flowchart illustrating an operation example of the imaging apparatus.

FIG. 6A is a diagram illustrating a graph of an ideal wavelength sweeping waveform.

FIG. 6B is a diagram illustrating nonlinearity of wavelength sweeping.

FIG. 7 is a flowchart illustrating an operation example of the imaging apparatus.

FIG. 8 is a flowchart illustrating an example of correction parameter update processing in FIG. 7.

FIG. 9 is a diagram illustrating correction of nonlinearity of the wavelength sweeping.

FIG. 10A is a diagram illustrating a temporal change in resolution of the imaging apparatus.

FIG. 10B is a diagram illustrating a temporal change in resolution of the imaging apparatus.

FIG. 11 is a flowchart illustrating an example of correction parameter update processing in FIG. 7.

### DETAILED DESCRIPTION

Set forth below with reference to the accompanying drawings is a detailed description of embodiments of an optical coherence tomographic imaging apparatus. In the respective drawings, parts having the same configuration or function are denoted by the same reference sign. In the description of the present embodiment, redundant description of the same part is sometimes appropriately omitted or simplified.

### First Embodiment

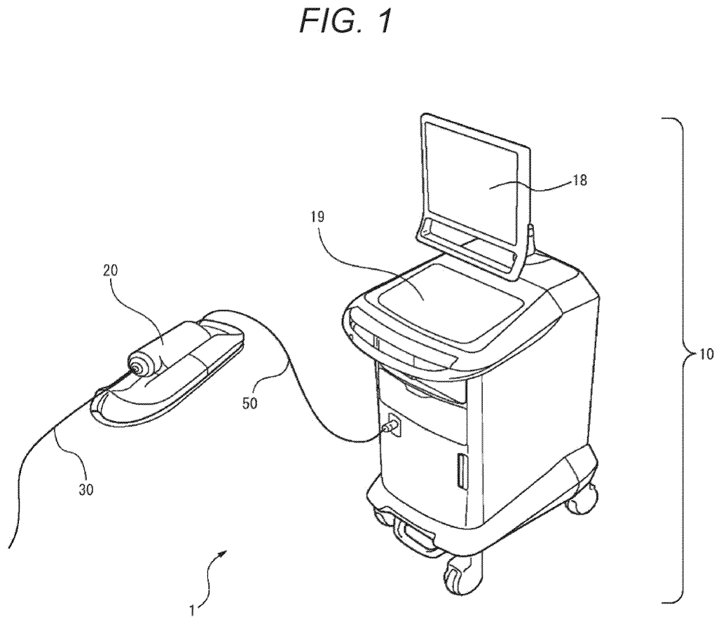

FIG. 1 is a diagram illustrating an example of an appearance of an imaging apparatus 1 as an optical coherence tomographic imaging apparatus according to an embodiment.

As illustrated in FIG. 1, the imaging apparatus 1 includes a control device 10, a drive unit 20, and a probe 30. The control device 10 and the drive unit 20 are connected to each other by a cable 50.

The control device 10 can control an entire operation of the imaging apparatus 1. Specifically, the control device 10 has a function of inputting various setting values, a function of transmitting and receiving light to and from the probe 30 via the drive unit 20, a function of processing data obtained by measurement and displaying the data as a tomographic image and the like when performing intracavity optical coherence tomography diagnosis. In the configuration in FIG. 1, a monitor 18 of the control device 10 is a display apparatus that displays various types of information such as a tomographic image. The monitor 18 can be, for example, a liquid crystal display (LCD) monitor, but maybe, for example, a monitor based on another method such as organic electro-luminescence (EL). An operation panel 19 receives an input of various setting values and instructions from a user. The operation panel 19 can be, for example, a keyboard and a pointing device, but may be a device based on another method such as a touch panel and a track ball.

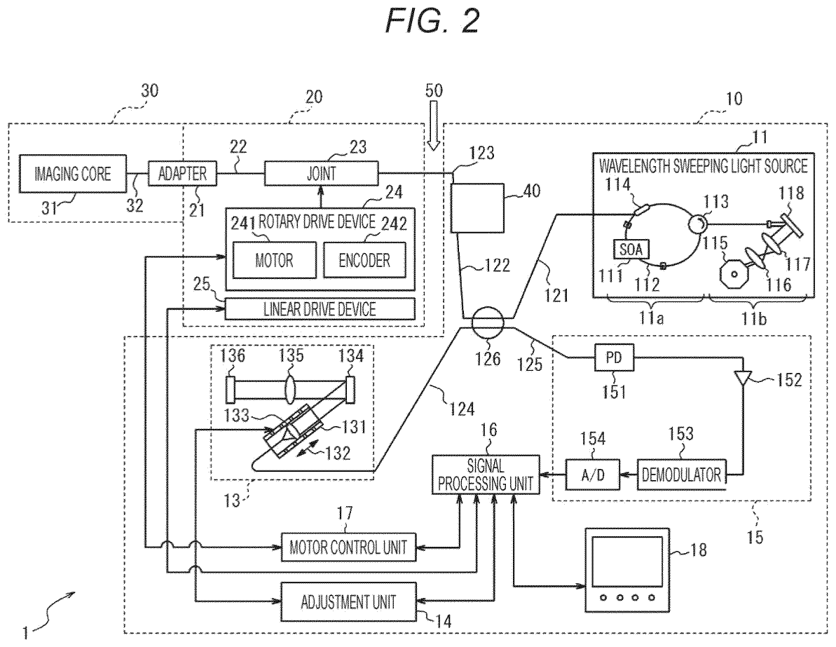

The drive unit 20 is connected to the probe 30 to drive the probe 30. Specifically, the drive unit 20 defines a radial operation of an imaging core 31 (refer to FIG. 2) in the probe 30 by drive of a built-in motor 241 (refer to FIG. 2). The drive unit 20 is also referred to as a motor drive unit (MDU).

The probe 30 is inserted into a body cavity such as a blood vessel and acquires a tomographic image of an object to be measured by the imaging core 31 (refer to FIG. 2) provided inside a distal end. The imaging core 31 continuously transmits measurement light transmitted from the control device 10 into the body cavity and continuously receives reflected light from the body cavity.

FIG. 2 is a block diagram illustrating an example of a functional configuration of the imaging apparatus 1 according to an embodiment.

As illustrated in FIG. 2, the control device 10 includes a wavelength sweeping light source 11, optical fibers 121 to 125, a coupler 126, a variable mechanism 13, an adjustment unit 14, an interference light processing unit 15, a signal processing unit 16, a motor control unit 17, the monitor 18, the operation panel 19, and a calibration unit 40. The drive unit 20 includes an adapter 21, an optical fiber 22, a joint 23, a rotary drive device 24, and a linear drive device 25. The probe 30 includes the imaging core 31 and an optical fiber 32.

The wavelength sweeping light source 11 outputs output light while periodically changing a wavelength. In an example in FIG. 2, the wavelength sweeping light source 11 is an extended-cavity laser that outputs coherent laser light by a swept laser. The wavelength sweeping light source 11 includes a ring unit 11a and a filter unit 11b.

The ring unit 11a outputs and amplifies the output light. The ring unit 11a includes a semiconductor optical amplifier (SOA) 111, an optical fiber 112, a circulator 113, and a coupler 114. In the ring unit 11a, the SOA 111, the circulator 113, and the coupler 114 are coupled in a ring shape by the optical fiber 112. The SOA 111 is a semiconductor element that applies antireflection treatment on both end faces of a semiconductor laser and performs optical amplification by induced emission on incident light from outside the semiconductor. The light output from the SOA 111 travels through the optical fiber 112 and enters the filter unit 11b.

The filter unit 11b performs wavelength selection from the light input from the ring unit 11a. The filter unit 11b includes a polygon mirror 115, lenses 116 and 117, and a diffraction grating 118. The light, the wavelength of which is selected by the filter unit 11b, is amplified by the SOA 111 and finally output from the coupler 114 to the optical fiber 121.

The filter unit 11b selects the wavelength by a combination of the diffraction grating 118 that disperses light and the polygon mirror 115. Specifically, the filter unit 11b condenses the light dispersed by the diffraction grating 118 on a surface of the polygon mirror 115 by the two lenses 116 and 117. As a result, only light having a wavelength orthogonal to the polygon mirror 115 returns through the same optical path and is output from the filter unit 11b. Therefore, time sweeping of the wavelength can be performed by rotating the polygon mirror 115. A micro electromechanical systems (MEMS) type wavelength-variable light source may be used as a light source for wavelength sweeping.

As the polygon mirror 115, for example, a 32-facet mirror may be used. A rotation speed of the polygon mirror 115 may be, for example, about 50,000 rpm. The wavelength sweeping light source 11 can perform high-speed and high-output wavelength sweeping by a wavelength sweeping method in which the polygon mirror 115 and the diffraction grating 118 are combined.

The optical fibers 121 to 125 transmit the output light output from the wavelength sweeping light source 11, the reflected light from the object to be measured, reference light, and interference light. Any of the optical fibers 121 to 125 may be a single-mode fiber in which light passes only through the center of the optical fiber.

The light of the wavelength sweeping light source 11 output from the coupler 114 is incident (i.e., received) at one end of the optical fiber 121 and transmitted toward a distal end side of the optical fiber 121. The optical fiber 121 is optically coupled to the optical fibers 122, 124, and 125 at the coupler 126 as an optical splitter on the way. Therefore, the light incident on the optical fiber 121 from the wavelength sweeping light source 11 is split into the measurement light and the reference light by the coupler 126. The measurement light is transmitted to the optical fiber 122. The reference light is transmitted to the optical fiber 124. The optical fiber 121 and the optical fiber 122 may be formed of a single optical fiber instead of being formed by coupling two optical fibers. Similarly, the optical fiber 124 and the optical fiber 125 may be formed of a single optical fiber.

A side away from the coupler 126 of the optical fiber 122 is connected to the joint 23 of the drive unit 20 via the calibration unit 40 and the optical fiber 123 to be described later. The optical fiber 123 forms the cable 50.

The joint (optical rotary joint portion, optical coupling portion) 23 couples a non-rotating portion (fixed portion) and a rotating portion (rotary drive unit) to transmit light. A distal end side of the optical fiber 22 in the joint 23 is detachably connected to the probe 30 via an adapter 21. As a result, light from the wavelength sweeping light source 11 is transmitted to the optical fiber 32 that is inserted into the imaging core 31 and can be rotary driven.

The transmitted light is applied to a biological tissue (object to be measured) in the body cavity from a distal end side of the imaging core 31 while performing a radial operation. That is, the imaging core 31 radially emits the measurement light by transmitting the measurement light to the outside of the probe 30 at predetermined time intervals while rotating in the probe 30. A part of the reflected light scattered on a surface or inside of the biological tissue is taken in by the imaging core 31 and returns to the optical fiber 121 side via a reverse optical path. Furthermore, a part of the light is shifted to the optical fiber 125 side by the coupler 126 and emitted from one end of the optical fiber 125, so that the light is received by the photodiode 151 of the interference light processing unit 15.

The rotary drive unit side of the joint 23 is rotary driven by the motor 241 of the rotary drive device 24 under the control of the motor control unit 17. A rotary angle of the motor 241 is detected by an encoder 242. Furthermore, the drive unit 20 includes a linear drive device 25 and defines an axial operation of the imaging core 31 on the basis of an instruction from the signal processing unit 16.

In contrast, the variable mechanism 13 of an optical path length for finely adjusting an optical path length of the reference light is provided at a distal end on the opposite side of the coupler 126 of the optical fiber 124. The variable mechanism 13 changes, so as to be able to absorb variation in length of each probe 30 in a case where the probe 30 is replaced to be used, the optical path length corresponding to the variation in length. The variable mechanism 13 includes a uniaxial stage 131, a moving direction 132, a collimate lens 133, a diffraction grating 134, a lens 135, and a mirror 136.

The optical fiber 124 and the collimate lens 133 are provided on the uniaxial stage 131 that is movable in the optical axis direction as indicated by the moving direction 132. The optical path length of the reference light can be changed by moving the optical fiber 124 and the collimate lens 133.

Specifically, the uniaxial stage 131 can move a distance sufficient for absorbing a variation in optical path length for each probe 30. The uniaxial stage 131 moves under the control of the adjustment unit 14. The adjustment unit 14 controls the movement of the uniaxial stage 131 on the basis of an instruction from the signal processing unit 16. With the movement of the uniaxial stage 131, the optical path length of the light passing through the diffraction grating 134, the lens 135, and the mirror 136 changes. Therefore, in a case where the probe 30 is replaced and the like, the uniaxial stage 131 functions as an optical path length changing means for absorbing the variation in the optical path length of the probe 30. Furthermore, the uniaxial stage 131 also has a function as an adjusting means that adjusts an offset. For example, even in a case where the distal end of the probe 30 is not in close contact with a surface of the biological tissue, it is possible to cause the reflected light from a surface position of the biological tissue and the reference light to interfere with each other by the uniaxial stage 131 slightly changing the optical path length.

The light, the optical path length of which is finely adjusted by the variable mechanism 13 of the optical path length, is mixed with the light obtained from the optical fiber 121 side by the coupler 126 provided in the middle of the optical fiber 124, and is incident on the interference light processing unit 15. The interference light processing unit 15 includes a photodiode 151, an amplifier 152, a demodulator 153, and an analog-to-digital (A/D) converter 154.

The photodiode 151 as a photoelectric converter photoelectrically converts the interference light when receiving the interference light between the reflected light from the biological tissue as the object to be measured and the reference light from the variable mechanism 13. The amplifier 152 amplifies the signal photoelectrically converted in the photodiode 151 and outputs the signal to the demodulator 153. The demodulator 153 performs demodulation processing of extracting only a signal component of the interference light from the signal amplified by the amplifier 152. The demodulator 153 outputs the demodulated signal to the A/D converter 154 as an interference light signal.

The A/D converter 154 performs analog-digital conversion on the interference light signal input from the demodulator 153. For example, the A/D converter 154 samples the interference light signal in analog format by 2,048 points at 180 MHz, for example, to generate one line of digital data (interference light data). Here, an example of the sampling frequency is set to 180 MHz because an example is assumed in which, in a case where a repetition frequency of the wavelength sweeping is set to 80 kHz, about 90% of a period (12.5 μsec) of the wavelength sweeping is extracted as 2,048 points of digital data. The period of the wavelength sweeping in the A/D converter 154 and the wavelength sweeping light source 11 is not limited to the period herein exemplified. The A/D converter 154 outputs the interference light data in units of lines to the signal processing unit 16.

The signal processing unit 16 controls the entire operation of the imaging apparatus 1. In a measurement mode, the signal processing unit 16 executes fast Fourier transform (FFT) on the interference light data input from the A/D converter 154 and generates data in a depth direction from frequency-resolved interference light data. The signal processing unit 16 performs coordinate transformation on the data in the depth direction to form a tomographic image at each position in the blood vessel, and outputs the tomographic image to the monitor 18 at a predetermined frame rate.

The signal processing unit 16 is further connected to the adjustment unit 14. As described above, the signal processing unit 16 controls the position of the uniaxial stage 131 via the adjustment unit 14. Furthermore, the signal processing unit 16 is connected to the motor control unit 17 and receives a video synchronization signal of the motor control unit 17. The signal processing unit 16 generates the tomographic image in synchronization with the received video synchronization signal.

The video synchronization signal of the motor control unit 17 is also transmitted to the rotary drive device 24. The rotary drive device 24 outputs a drive signal synchronized with the video synchronization signal to the joint 23.

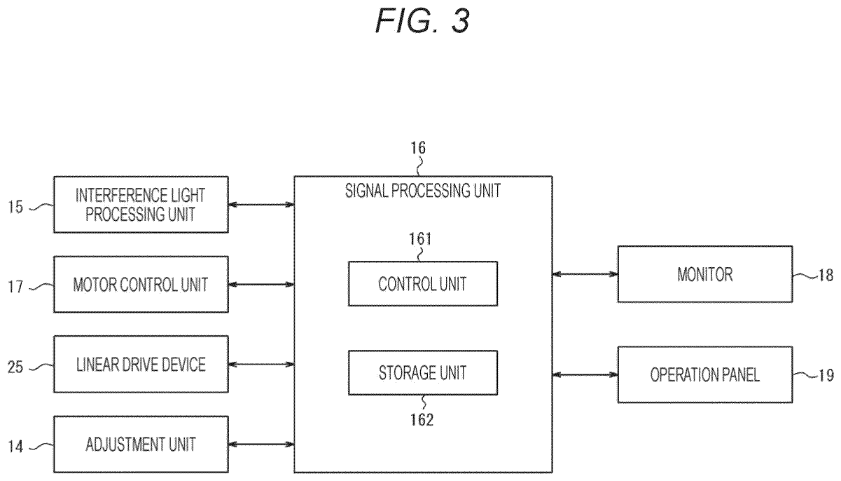

FIG. 3 is a block diagram illustrating a configuration example of the signal processing unit 16 and other functional elements in FIG. 2. As illustrated in FIG. 3, the signal processing unit 16 includes a control unit 161 and a storage unit 162.

The control unit 161 includes one or more processors. In an embodiment, the “processor” is a general-purpose processor, or a dedicated processor specialized for specific processing, but is not limited to a general-purpose processor or a dedicated processor specialized for specific processing. The control unit 161 is communicably connected to each component that forms the imaging apparatus 1 and controls the entire operation of the imaging apparatus 1. As illustrated in FIG. 3, for example, the control unit 161 controls the operations of the adjustment unit 14, the interference light processing unit 15, the motor control unit 17, the monitor 18, the operation panel 19, and the linear drive device 25, but may control other configurations.

The storage unit 162 includes any storage module such as a hard disk drive (HDD), a solid state drive (SSD), a read-only memory (ROM), and a random access memory (RAM), for example. The storage unit 162 may function as, for example, a main storage device, an auxiliary storage device, or a cache memory. The storage unit 162 stores any information used for the operation of the imaging apparatus 1. For example, the storage unit 162 may store a system program, an application program, various types of information such as a correction parameter for correcting a tomographic image and the like. The storage unit 162 is not limited to a storage module built in the imaging apparatus 1 and may be an external database or an external storage module.

The function of the signal processing unit 16 may be implemented by executing a program (computer program) according to the present embodiment by a processor included in the control unit 161. That is, the function of the signal processing unit 16 may be implemented by software. The program causes a computer to execute processing of steps included in the operation of the signal processing unit 16, thereby causing the computer to implement a function corresponding to the processing at each step.

Some or all of the functions of the signal processing unit 16 may be implemented by a dedicated circuit included in the control unit 161. That is, some or all of the functions of the signal processing unit 16 may be implemented by hardware. The signal processing unit 16 may be implemented by a single computer or may be implemented by cooperation of a plurality of computers.

As described above, the signal processing unit 16 acquires the tomographic image of the object to be measured on the basis of the interference light between the reflected light from the object to be measured and the reference light. As described later, the tomographic image simply reflecting the interference light does not have sufficient resolution due to nonlinearity based on wavelength sweeping, dispersion of an optical fiber and the like. The signal processing unit 16 performs arithmetic processing on an electric signal related to the tomographic image on the basis of the correction parameter, thereby reducing an influence based on the nonlinearity. Note that a profile related to such correction might cause drift due to repeated use, a change in temperature, long-term use and the like of the imaging apparatus 1. Therefore, even if the tomographic image is corrected using the correction parameter set at the time of factory shipment, there is a case where the tomographic image having sufficient resolution cannot be acquired. The imaging apparatus 1 according to the present embodiment implements high resolution by performing measurement for acquiring the correction parameter and updating the correction parameter even after the factory shipment.

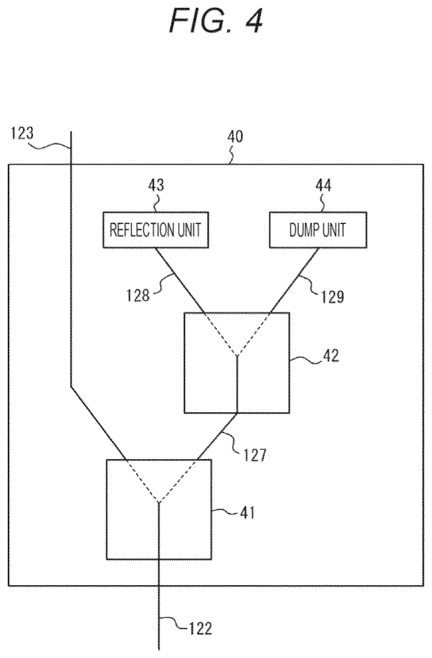

In the present embodiment, the imaging apparatus 1 updates the correction parameter using the calibration unit 40. FIG. 4 is a block diagram illustrating a configuration example of the calibration unit 40 in FIG. 2. The calibration unit 40 includes optical switches 41 and 42, a reflection unit 43, a dump unit 44, and optical fibers 127 to 129.

The optical switch 41 as a switching unit switches an optical path optically connected to the optical fiber 122 between the optical fiber 123 and the optical fiber 127. The optical switch 42 switches an optical path optically connected to the optical fiber 127 between the optical fiber 128 and the optical fiber 129. The optical switches 41 and 42 may be implemented by any method of switching the optical path in an optical transmission line, and maybe, for example, an optical switch of a mechanical method, a MEMS method, or an optical waveguide method. The optical switches 41 and 42 may switch the optical path on the basis of the control of the signal processing unit 16. In normal measurement for acquiring the tomographic image of the object to be measured, the optical switch 41 optically connects the optical fiber 122 and the optical fiber 123. The optical switch 41 may have a configuration of adopting one switch of three-channel switching type and not using the optical switch 42.

The optical fiber 128 is connected to the reflection unit 43. The reflection unit 43 as a reflector is an optical device that reflects incident light. The reflection unit 43 may be a mirror, reflectance of which is adjusted according to a dynamic range of the photodiode 151. As described later, the imaging apparatus 1 acquires the correction parameter using the reflected light from the reflection unit 43.

The dump unit 44 attenuates light by, for example, winding the optical fiber with a small diameter or applying end face treatment of an optical fiber end so that an amount of reflected light is sufficiently below a detectable limit so as not to cause total reflection of light in the optical fiber. The dump unit 44 is used to acquire data in a state in which no interference light is incident on the photodiode 151 and perform zero adjustment so that a corresponding output becomes zero.

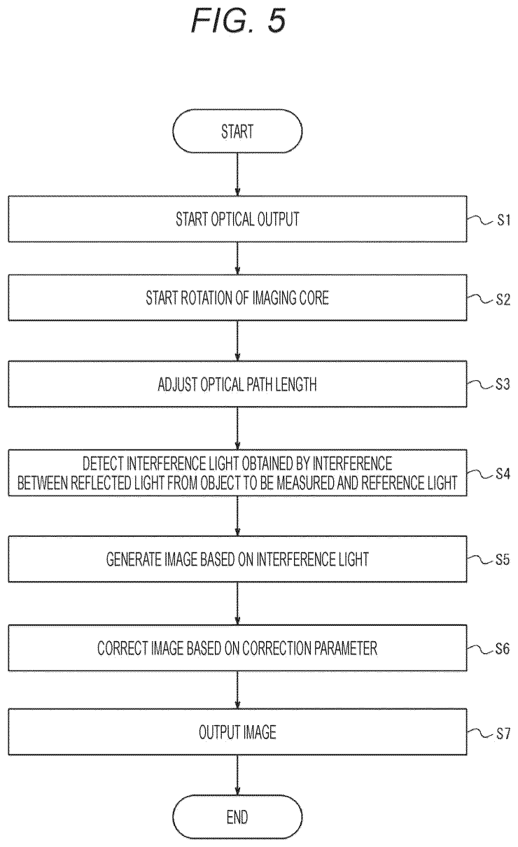

An operation of the imaging apparatus 1 for acquiring the tomographic image of the object to be measured will be described with reference to FIG. 5. FIG. 5 is a flowchart illustrating an operation example of the imaging apparatus 1. The operation of the imaging apparatus 1 described with reference to FIG. 5 may correspond to one of the control methods of the imaging apparatus 1. The operation at each step in FIG. 5 may be executed on the basis of control by the control unit 161 of the imaging apparatus 1.

At S1, the control unit 161 starts an optical output from the wavelength sweeping light source 11. Specifically, the control unit 161 controls the wavelength sweeping light source 11 to perform optical output and optical amplification in the SOA 111 while rotating the polygon mirror 115. As a result, the wavelength sweeping light source 11 outputs output light, a wavelength of which changes at a high frequency, to the optical fiber 121. As a result, light is output from the imaging core 31 via the optical fibers 122 and 123, the drive unit 20, and the optical fiber 32.

At S2, the control unit 161 controls the motor control unit 17 and the linear drive device 25 to start the rotation of the imaging core 31. As a result, the measurement light is radially emitted from the imaging core 31, and measurement of the reflected light around the imaging core 31 is started.

At S3, the control unit 161 controls the adjustment unit 14 to adjust an optical path length difference such that the reflected light from the object to be measured and the reference light can interfere with each other on the coupler 126. The order of the processing at S1 to S3 may be changed.

At S4, the control unit 161 detects, by the photodiode 151, the interference light obtained by interference between the reflected light from the object to be measured and the reference light.

At S5, the control unit 161 generates the tomographic image of the object to be measured on the basis of the interference light detected by the photodiode 151.

At S6, the control unit 161 corrects the tomographic image on the basis of the correction parameter stored in advance in the storage unit 162.

At S7, the control unit 161 outputs the corrected tomographic image. For example, the control unit 161 may output the tomographic image to the monitor 18 to display or may output the tomographic image to the storage unit 162 to store. When the processing at S7 is finished, the control unit 161 finishes the processing of the flowchart in FIG. 5.

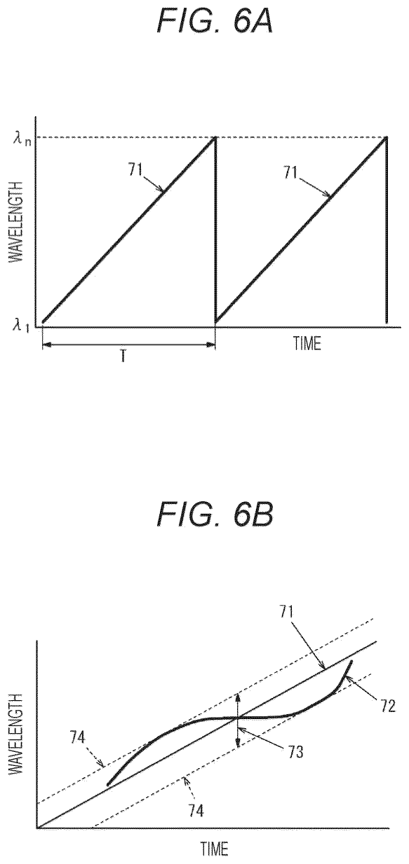

Here, the significance of the correction parameter at S6 will be described with reference to FIGS. 6A and 6B. FIG. 6A is a diagram illustrating a graph 71 of an ideal wavelength sweeping waveform. In FIG. 6A, the abscissa represents time, and the ordinate represents a wavelength. The graph 71 illustrates a wavelength that changes from a wavelength λ₁ to a wavelength λ₂ at a constant change rate in a period T. As illustrated in FIG. 6A, ideally, a wavelength change rate with respect to the time is required to be linear.

FIG. 6B is a diagram illustrating nonlinearity of the wavelength sweeping. In FIG. 6B, the abscissa represents time, and the ordinate represents a wavelength. A graph 72 illustrates a change in the wavelength of the light output from the wavelength sweeping light source 11 in one period of the graph 71 in FIG. 6A. As illustrated in FIG. 6B, the graph 72 has an error 73 corresponding to a length between dotted lines 74 with respect to the graph 71.

In this manner, the change in wavelength (graph 72) of the light output from the wavelength sweeping light source 11 changes nonlinearly unlike an ideal change (graph 71). This causes a deterioration in resolution of the obtained tomographic image. The correction parameter includes information for correcting such nonlinearity of the wavelength sweeping. The correction parameter for correcting such nonlinearity of the wavelength sweeping may be given, for example, as information indicating a correspondence relationship between time in one period and a correction amount (for example, an increase/decrease amount) of the wavelength.

A factor that can cause the deterioration in resolution of the tomographic image is not limited to the nonlinearity of the wavelength sweeping. For example, dispersion of the optical fiber might also cause the deterioration in resolution. Dispersion refers to a phenomenon in which a propagation time through a substance varies depending on the wavelength (frequency) of light. The optical fiber is made of quartz glass or the like, and a speed of light propagated through the optical fiber varies depending on the wavelength. The signal processing unit 16 performs processing of converting the tomographic image output from the A/D converter 154 into a tomographic image acquired in a state in which the speed of light for each wavelength is constant, using the correction parameter acquired in advance.

As described above, the state of the imaging apparatus 1 changes from the state at the time of factory shipment due to the repeated use, change in temperature, long-term use and the like of the imaging apparatus 1. Therefore, there is a case where the imaging apparatus 1 cannot obtain a tomographic image with sufficient resolution depending on the correction parameter set at the time of factory shipment. Therefore, the imaging apparatus 1 according to the present embodiment acquires the correction parameter corresponding to the state of the imaging apparatus 1 and performs processing of updating the correction parameter stored in the storage unit 162.

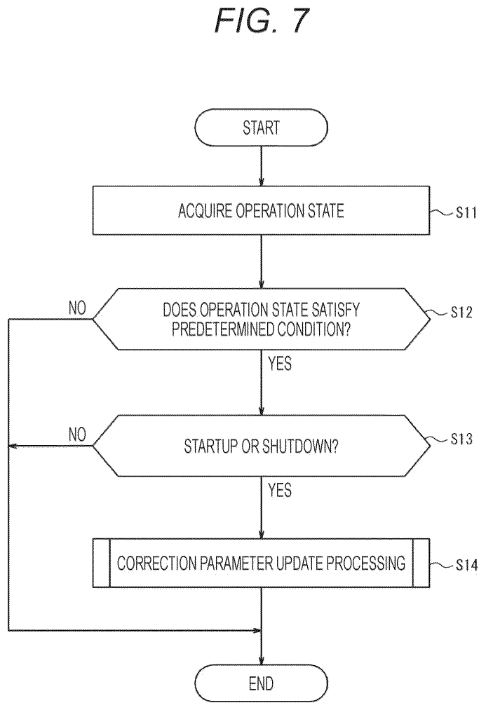

An operation for the imaging apparatus 1 to update the correction parameter will be described with reference to FIG. 7. FIG. 7 is a flowchart illustrating an operation example of the imaging apparatus 1. The operation of the imaging apparatus 1 described with reference to FIG. 7 may correspond to one of the control methods of the imaging apparatus 1. The operation at each step in FIG. 7 may be executed on the basis of control by the control unit 161 of the imaging apparatus 1.

At S11, the control unit 161 acquires the operation state of the imaging apparatus 1. Specifically, for example, the control unit 161 may acquire at least any information of the temperature and the operation time of the imaging apparatus 1 as information indicating the operation state of the imaging apparatus 1. Here, the operation time of the imaging apparatus 1 is an elapsed time after startup but may be a total time during which the imaging apparatus 1 has been operated after the factory shipment.

At S12, the control unit 161 determines whether or not the operation state acquired at S11 satisfies a predetermined condition. For example, in a case where the temperature of the imaging apparatus 1 is equal to or higher than a predetermined first threshold, or the operation time of the imaging apparatus 1 is equal to or longer than a predetermined second threshold, or both of them are satisfied, the control unit 161 may determine that the operation state of the imaging apparatus 1 satisfies the predetermined condition. In a case where the operation state of the imaging apparatus 1 satisfies the predetermined condition (YES at S12), the control unit 161 proceeds to S13, and otherwise (NO at S12), this finishes the processing of the flowchart in FIG. 7.

At S13, the control unit 161 determines whether the imaging apparatus 1 performs a startup operation or a shutdown operation. Here, the “startup operation” refers to a series of operations executed in accordance with startup of the imaging apparatus 1. The “shutdown operation” refers to a series of operations executed in accordance with shutdown of the imaging apparatus 1.

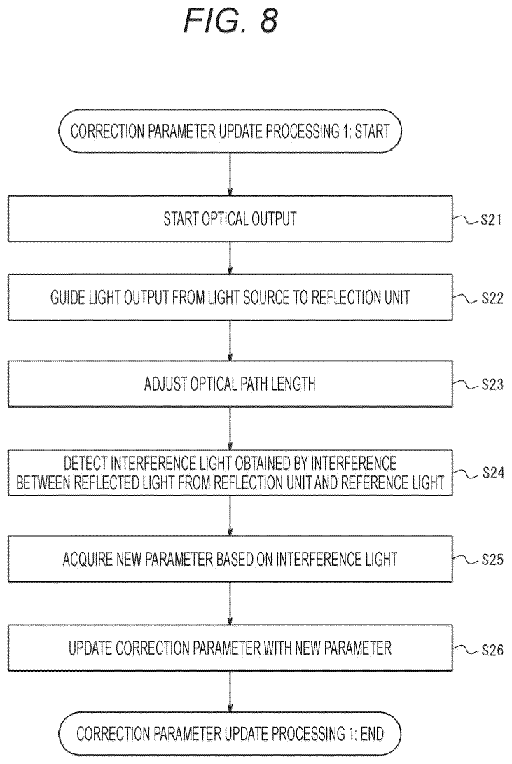

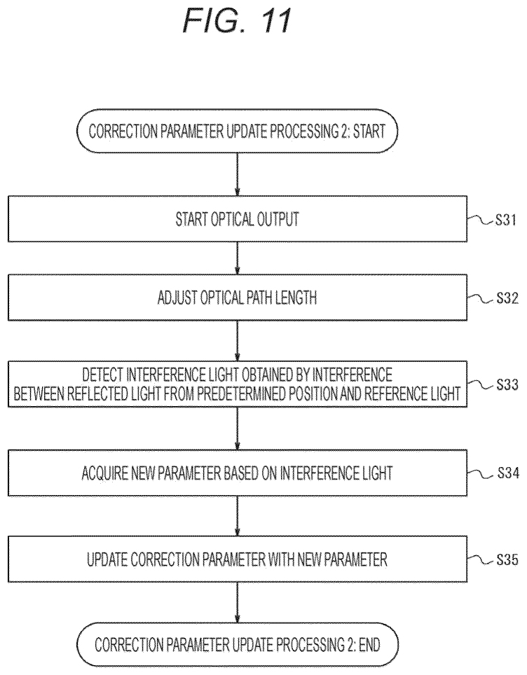

At S14, the control unit 161 executes correction parameter update processing. The correction parameter update processing refers to processing of newly measuring the correction parameter and updating the correction parameter stored in the storage unit 162. The correction parameter update processing will be described later in detail with reference to FIGS. 8 and 11. When the processing at S14 is finished, the control unit 161 finishes the processing of the flowchart in FIG. 7.

In this manner, the imaging apparatus 1 executes the correction parameter update processing by setting a fact that the operation state of the imaging apparatus 1 satisfies the predetermined condition as one of necessary conditions (YES at S12). For example, the imaging apparatus 1 executes the correction parameter update processing by setting a fact that at least either the temperature or the operation time of the imaging apparatus 1 satisfies the predetermined condition as one of necessary conditions. Therefore, the imaging apparatus 1 can acquire a highly useful correction parameter in a state in which the operation is stable, update the correction parameter, and acquire a tomographic image with higher resolution.

The imaging apparatus 1 executes the correction parameter update processing in conjunction with the startup operation or the shutdown operation of the imaging apparatus 1 (YES at S13). Therefore, the imaging apparatus 1 can acquire a highly useful correction parameter without hindering the use of the device by the user.

FIG. 8 is a flowchart illustrating an example of the correction parameter update processing (S14) in FIG. 7. The operation of the imaging apparatus 1 described with reference to FIG. 8 may correspond to one of the control methods of the imaging apparatus 1. The operation at each step in FIG. 8 may be executed on the basis of control by the control unit 161 of the imaging apparatus 1.

At S21, the control unit 161 starts an optical output from the wavelength sweeping light source 11. Specific processing is similar in detail to the processing described above with reference to S1 in FIG. 5.

At S22, the control unit 161 guides the light output from the wavelength sweeping light source 11 to the reflection unit 43 of the calibration unit 40. Specifically, the control unit 161 controls the optical switches 41 and 42 of the calibration unit 40 such that the optical fiber 122 is optically connected to the optical fiber 127 and the optical fiber 127 is optically connected to the optical fiber 128.

At S23, the control unit 161 controls the adjustment unit 14 to adjust the optical path length difference such that the reflected light from the reflection unit 43 and the reference light can interfere with each other on the coupler 126. The order of the processing at S21 to S23 may be changed.

At S24, the control unit 161 detects, by the photodiode 151, the interference light obtained by interference between the reflected light from the reflection unit 43 and the reference light.

At S25, the control unit 161 acquires a new correction parameter on the basis of the interference light detected by the photodiode 151.

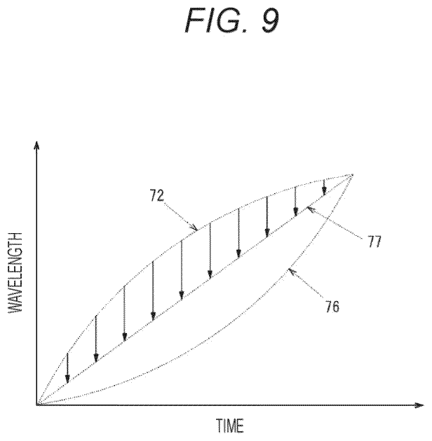

Processing of acquiring the correction parameter for correcting the nonlinearity of the wavelength sweeping will be described with reference to FIG. 9. FIG. 9 is a diagram illustrating correction of nonlinearity of the wavelength sweeping. In FIG. 9, the abscissa represents time, and the ordinate represents a wavelength. A graph 72 illustrates a change in the wavelength of the light output from the wavelength sweeping light source 11 in one period of the wavelength sweeping as in FIG. 6B. A graph 77 illustrates a change in wavelength of light in ideal wavelength sweeping. The control unit 161 calculates differences between wavelengths at a plurality of times between the graphs 72 and 77 and subtracts the differences from the wavelength of the graph 77 to acquire a graph 76 for correction. For each time, an average of the wavelengths is calculated between the graph 72 and graph 76 to obtain a graph 77. Therefore, for example, the control unit 161 may acquire values of the wavelength of the graph 76 at a plurality of times as the correction parameters. Alternatively, for example, the control unit 161 may acquire the differences between the wavelength values of the graph 72 and the graph 77 at a plurality of times as the correction parameters.

Processing of acquiring the correction parameter for correcting the nonlinearity of the wavelength sweeping is not limited to the processing described above with reference to FIG. 9 and may be executed on the basis of any method. The imaging apparatus 1 may acquire the correction parameter for correcting nonlinearity based on a cause other than wavelength sweeping, such as dispersion of an optical fiber. For example, the control unit 161 may acquire the correction parameter for correcting the nonlinearity caused by the dispersion of the optical fiber on the basis of a method disclosed in Non Patent Literatures 1 and 2 mentioned below or the like.

### Non Patent Literature 1

M. Wojtkowski, V. Srinivasan, T. Ko, J. Fujimoto, A. Kowalczyk, and J. Duker, “Ultrahigh-resolution, highspeed, Fourier domain optical coherence tomography and methods for dispersion compensation,” Opt. Express 12(11), 2404-2422 (2004).

### Non Patent Literature 2

M. Wojtkowski, T. Bajraszewski, I. Gorczynska, P. Targowski, A. Kowalczyk, W. Wasilewski, and C. Radzewicz, “Ophthalmic imaging by spectral optical coherence tomography,” Am. J. Ophthalmol. 138(3), 412-419 (2004).

When acquiring the correction parameter, the control unit 161 may guide the light output from the wavelength sweeping light source 11 to the dump unit 44 of the calibration unit 40 to perform zero adjustment. Specifically, the control unit 161 controls the optical switches 41 and 42 of the calibration unit 40 such that the optical fiber 122 is optically connected to the optical fiber 127 and the optical fiber 127 is optically connected to the optical fiber 129. In this case, since the measurement light is guided to the dump unit 44, the intensity of the interference light is ideally zero. Nevertheless, the signal detected as the intensity of the interference light by the photodiode 151 corresponds to noise. Therefore, the control unit 161 may normalize the signal so as not to generate such noise and acquire the correction parameter. By acquiring the correction parameter by performing such zero adjustment, the imaging apparatus 1 can acquire a more highly useful correction parameter and acquire a tomographic image with higher resolution.

The description returns to FIG. 8. At S26, the control unit 161 updates the correction parameter stored in the storage unit 162 with the new parameter acquired at S25. When the processing at S26 is finished, the control unit 161 finishes the correction parameter update processing 1 in FIG. 8.

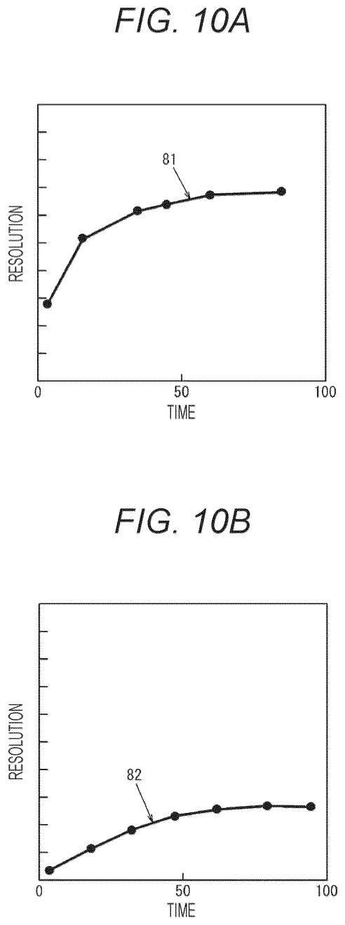

FIGS. 10A and 10B are diagrams illustrating a temporal change in resolution of the imaging apparatus 1. In FIGS. 10A and 10B, the abscissa represents an elapsed time after startup of the imaging apparatus 1, and the ordinate represents resolution of the imaged tomographic image of the object to be measured. In FIG. 10A, a graph

schematically illustrates a change in resolution after startup of the imaging apparatus 1 used for a certain period after the factory shipment. A graph 81 schematically illustrates a state in which the resolution of the tomographic image deteriorates with a lapse of time after startup. In FIG. 10B, a graph 82 schematically illustrates a change in resolution after startup of the same imaging apparatus 1 used for a certain period after the factory shipment in a case where the correction parameter is updated. The graph 82 also illustrates a state in which the resolution of the tomographic image deteriorates with the lapse of time after startup, but it can be seen that the resolution is small and is excellently kept as compared with the graph 81. There is a case where the resolution of the imaging apparatus 1 at cold state (i.e., from startup until completion of warm-up) is not better than that in a case where warm-up is completed. Therefore, the imaging apparatus 1 can maintain excellent resolution by periodically updating the correction parameter until the warm-up is completed after startup.

As described above, the imaging apparatus 1 includes the wavelength sweeping light source 11, the coupler 126, the photodiode 151, the signal processing unit 16, and the calibration unit 40. The wavelength sweeping light source 11 outputs output light while periodically changing a wavelength. The coupler 126 splits the output light output from the wavelength sweeping light source 11 into the measurement light and the reference light. The photodiode 151 converts light intensity of the interference light obtained by interference between the reference light and the reflected light of the measurement light with which the object to be measured is irradiated via a first optical path through which the measurement light is propagated from the coupler 126 to the object to be measured into an electric signal. The signal processing unit 16 performs arithmetic processing on the electric signal on the basis of the correction parameter stored in the storage unit 162 to acquire the tomographic image of the object to be measured. The calibration unit 40 is provided in the first optical path. The optical switches 41 and 42 of the calibration unit 40 switch a propagation destination of the measurement light between the object to be measured and a second optical path provided with the reflection unit 43 at the end of the calibration unit 40. Here, in a state in which the measurement light is propagated to the reflector via the second optical path, the signal processing unit 16 updates the correction parameter stored in the storage unit 162 on the basis of the interference light obtained by the interference between the reference light and the reflected light of the measurement light with which the reflection unit 43 is irradiated via the second optical path.

In this manner, the imaging apparatus 1 does not use the correction parameter set in advance but updates the correction parameter on the basis of the latest state of the apparatus. Therefore, the correction parameter can be optimized according to the state of the apparatus, and a tomographic image with higher resolution than that of the conventional configuration can be acquired.

The signal processing unit 16 may acquire a parameter for canceling the influence of the nonlinear change in the wavelength of the output light output from the wavelength sweeping light source 11 with respect to time, that is, the nonlinearity caused by the wavelength sweeping on the basis of the interference light obtained by the interference between the reference light and the reflected light of the measurement light with which the reflection unit 43 is irradiated via the second optical path. The signal processing unit 16 may update the correction parameter stored in the storage unit 162 with the acquired parameter.

In this manner, the imaging apparatus 1 may acquire a parameter for acquiring the tomographic image in a case where the wavelength of the output light output from the wavelength sweeping light source 11 linearly changes with respect to time on the basis of the interference light acquired via the second optical path. Therefore, the imaging apparatus 1 can acquire a tomographic image with higher resolution even in a case where a sweeping speed of the wavelength sweeping light source 11 is not constant.

The signal processing unit 16 may acquire a parameter for canceling the influence of variation by a wavelength in propagation speeds of the measurement light propagated through the first optical path and the reference light, that is, the nonlinearity caused by the dispersion of the optical fiber on the basis of the interference light obtained by the interference between the reference light and the reflected light of the measurement light with which the reflection unit 43 is irradiated via the second optical path. The signal processing unit 16 may update the correction parameter stored in the storage unit 162 with the acquired parameter.

In this manner, the imaging apparatus 1 may acquire a parameter for acquiring a tomographic image in a case where the propagation speeds of the measurement light propagated through the first optical path and the reference light are the same on the basis of the interference light acquired via the second optical path. Therefore, the imaging apparatus 1 can acquire a tomographic image with higher resolution by suppressing an influence of a difference in propagation speed of light in the optical fiber depending on the wavelength.

The optical switches 41 and 42 of the calibration unit 40 may switch the propagation destination of the measurement light from the object to be measured to the second optical path on the basis of the operation state of the imaging apparatus 1. The signal processing unit 16 may update the correction parameter stored in the storage unit 162 on the basis of the interference light obtained by interference between the reference light and the reflected light of the measurement light with which the reflection unit 43 is irradiated in a state in which the measurement light is propagated to the reflection unit 43 via the second optical path.

In this manner, the imaging apparatus 1 may acquire the correction parameter by switching the propagation destination of the measurement light from the object to be measured to the second optical path on the basis of the operation state of the imaging apparatus 1. Therefore, the imaging apparatus 1 can acquire a highly useful correction parameter in a state in which the operation of the apparatus is stable and can acquire a tomographic image with higher resolution.

The optical switches 41 and 42 of the calibration unit 40 may switch the propagation destination of the measurement light from the object to be measured to the second optical path in a case where it is detected that at least either the temperature or the operation time of the imaging apparatus 1 satisfies a predetermined condition as the operation state of the imaging apparatus 1.

In this manner, by acquiring the correction parameter in a case where at least either the temperature or the operation time of the imaging apparatus 1 satisfies a certain condition, the imaging apparatus 1 can accurately determine a state in which the operation of the apparatus is stable and acquire the highly useful correction parameter.

In a case where it is detected that at least either the temperature or the operation time of the imaging apparatus 1 satisfies a predetermined condition, the optical switches 41 and 42 of the calibration unit 40 may switch the propagation destination of the measurement light from the object to be measured to the second optical path in conjunction with the startup operation or the shutdown operation of the imaging apparatus 1.

In this manner, by executing the processing of acquiring the correction parameter in conjunction with the startup operation or the shutdown operation of the imaging apparatus 1, the imaging apparatus 1 can acquire a highly useful correction parameter without hindering the use of the device by the user.

### Second Embodiment

In the first embodiment, the example has been described in which the calibration unit 40 is provided, the calibration unit 40 analyzes the interference light between the reference light and the reflection light of the measurement light in the reflection unit 43 to acquire the correction parameter, and the correction parameter stored in the storage unit 162 is updated. Note that the correction parameter can be acquired without providing the calibration unit 40. In the present embodiment, the imaging apparatus 1, not including the calibration unit 40 acquires the correction parameter. Specifically, the imaging apparatus 1 according to the present embodiment adjusts the optical path length difference such that the reference light and the reflected light of the measurement light from a connection surface of different materials in the optical path, a crack in the optical fiber in the optical path and the like can interfere with each other on the coupler 126. The imaging apparatus 1 acquires and updates the correction parameter on the basis of such interference light. Therefore, the imaging apparatus 1 according to the present embodiment can acquire and update the correction parameter without including the calibration unit 40.

Most of the configuration and operation of the imaging apparatus 1 as the optical coherence tomographic imaging apparatus according to the present embodiment are common to those of the imaging apparatus 1 according to the first embodiment. Therefore, in the present embodiment, differences from the first embodiment will be mainly described, and detailed description of other parts will be omitted.

An appearance of the imaging apparatus 1 according to the present embodiment is illustrated in FIG. 1, for example, as in the first embodiment. A functional configuration of the imaging apparatus 1 according to the present embodiment can be, for example, a configuration obtained by removing the calibration unit 40 from FIG. 2. Therefore, a configuration example in which the optical fiber 122 is directly connected to the joint 23 in FIG. 2 will be described below as the imaging apparatus 1 according to the present embodiment.

In order to acquire the correction parameter, the imaging apparatus 1 according to the present embodiment causes the reflected light from the optical path between the coupler 126 and the imaging core 31 in FIG. 2 and the reference light to interfere with each other on the coupler 126. Such reflected light can be, for example, the reflected light from the connection surface of different materials in the optical path, the crack in the optical fiber in the optical path or the like. The connection surface of different materials is a contact surface of media having different refractive indices. Specifically, the contact surface of different materials may be present, for example, between the optical fiber 32 and the optical fiber 22 in the adapter 21, or between the optical fiber and air, liquid (for example, oil and the like) or the like. The contact surface of the optical fiber and air, liquid or the like may be present, for example, between the imaging core 31 and air or liquid, between the optical fiber 22 and the optical fiber 123 in the joint 23 or the like. The crack in the optical path can be, for example, a crack at a predetermined position in the optical path between the coupler 126 and the imaging core 31. Such crack is a slight crack and the like that does not affect the measurement of the tomographic image of the object to be measured.

In a case where the reflected light from such connection surface of different materials or crack in the optical path is used, magnitude of the reflection can be set to a desired value by processing a shape of the connection surface or crack. For example, on the contact surface between the optical fibers 32 and 22 in the adapter 21, misalignment of the air layer and core and the like occurs according to processing accuracy at a surface contact portion of the optical fibers 32 and 22, surface angles and the like. Therefore, by processing the surface contact portion of the optical fibers 32 and 22, it is possible to set the magnitude of reflection at the surface contact portion to a desired value and generate a parameter.

In the present embodiment, since the reflected light from the optical path between the coupler 126 and the imaging core 31 and the reference light can interfere on the coupler 126, the imaging apparatus 1 needs to be able to change the optical path length in a longer range than that of the first embodiment. Therefore, the imaging apparatus 1 may include the variable mechanism 13 capable of adjusting the optical path length in a longer range than in the first embodiment. For example, the imaging apparatus 1 may include a plurality of variable mechanisms 13 connected in series with each other. The intensity of the reflected light from the crack, the connection surface or the like is generally smaller than the intensity of the reflected light from the object to be measured, the reflection unit 43 and the like. Therefore, the imaging apparatus 1 may include the photodiode 151 having higher sensitivity than that in the first embodiment.

In the present embodiment also, the configuration of the signal processing unit 16 is illustrated in FIG. 3 as in the first embodiment. The operation for the imaging apparatus 1 according to the present embodiment to acquire the tomographic image of the object to be measured is illustrated in FIG. 5 similarly to the first embodiment. The entire flow of the operation for the imaging apparatus 1 according to the present embodiment to update the correction parameter is illustrated in FIG. 7 similarly to the first embodiment.

The correction parameter update processing executed by the imaging apparatus 1 according to the present embodiment at S14 in FIG. 7 will be described with reference to FIG. 11. FIG. 11 is a flowchart illustrating an example of the correction parameter update processing in FIG. 7. The operation of the imaging apparatus 1 described with reference to FIG. 11 may correspond to one of the control methods of the imaging apparatus 1. The operation at each step in FIG. 11 may be executed on the basis of control by the control unit 161 of the imaging apparatus 1.

At S31, the control unit 161 starts an optical output from the wavelength sweeping light source 11. Specific processing is similar in detail to the processing described above with reference to S1 in FIG. 5.

At S32, the control unit 161 controls the adjustment unit 14 to adjust the optical path length difference such that the reflected light from the predetermined position in the optical path from the coupler 126 to the imaging core 31 and the reference light can interfere with each other on the coupler 126. Specifically, the control unit 161 may adjust the optical path length so that the interference light between the reference light and the reflected light from a position of the crack or a specific joint surface in the optical path from the coupler 126 to the imaging core 31 can be detected.

At S33, the control unit 161 detects, by the photodiode 151, the interference light obtained by interference between the reflected light from the predetermined position and the reference light.

At S34, the control unit 161 acquires a new correction parameter on the basis of the interference light detected by the photodiode 151. Specifically, the control unit 161 may acquire the new correction parameter by processing similar to that at S25 in FIG. 8.

At S35, the control unit 161 updates the correction parameter stored in the storage unit 162 with the new parameter acquired at S34. When the processing at S35 is finished, the control unit 161 finishes correction parameter update processing 2 in FIG. 11.

As described above, the imaging apparatus 1 includes the wavelength sweeping light source 11, the coupler 126, the photodiode 151, the signal processing unit 16, and the adjustment unit 14. The wavelength sweeping light source 11 outputs output light while periodically changing a wavelength. The coupler 126 splits the output light output from the wavelength sweeping light source 11 into the measurement light and the reference light. The photodiode 151 converts light intensity of the interference light obtained by interference between the reference light and the reflected light of the measurement light with which the object to be measured is irradiated via a first optical path through which the measurement light is propagated from the coupler 126 to the object to be measured into an electric signal. The signal processing unit 16 performs arithmetic processing on the electric signal on the basis of the correction parameter stored in the storage unit 162 to acquire the tomographic image of the object to be measured. The adjustment unit 14 adjusts the optical path length so that the photodiode 151 detects the light intensity of the interference light obtained by the interference between the reference light and the reflected light from a predetermined position determined in advance in the first optical path. The signal processing unit 16 updates the correction parameter stored in the storage unit 162 on the basis of the interference light obtained by interference between the reference light and the reflected light from the predetermined position.

In this manner, the imaging apparatus 1 does not use the correction parameter set in advance but updates the correction parameter on the basis of the latest state of the apparatus. Therefore, the correction parameter can be optimized according to the state of the apparatus, and a tomographic image with higher resolution than that of the conventional configuration can be acquired.

The signal processing unit 16 may update the correction parameter stored in the storage unit 162 on the basis of the interference light obtained by the interference between the reference light and the reflected light from the position of the connection surface of different materials in the first optical path or the position of the crack of the material through which the measurement light is propagated as the predetermined position.

In this manner, the imaging apparatus 1 may update the correction parameter on the basis of the reflected light from the position of the connection surface of different materials in the existing first optical path or the position of the crack of the material through which the measurement light is propagated in the first optical path. Therefore, the imaging apparatus 1 can optimize the correction parameter without providing a new component.

The signal processing unit 16 may acquire a parameter for canceling the influence of the nonlinear change in the wavelength of the output light output from the wavelength sweeping light source 11 with respect to time, that is, the nonlinearity caused by the wavelength sweeping on the basis of the interference light obtained by the interference between the reference light and the reflected light of the measurement light from the predetermined position, and update the correction parameter stored in the storage unit 162 by the acquired parameter.

In this manner, the imaging apparatus 1 may acquire a parameter for acquiring the tomographic image in a case where the wavelength of the output light output from the wavelength sweeping light source 11 linearly changes with respect to time on the basis of the interference light acquired on the basis of the reflected light of the measurement light from the predetermined position. Therefore, the imaging apparatus 1 can acquire a tomographic image with higher resolution even in a case where a sweeping speed of the wavelength sweeping light source 11 is not constant.

The signal processing unit 16 may acquire a parameter for canceling the influence of variation by a wavelength in propagation speeds of the measurement light propagated through the first optical path and the reference light, that is, the nonlinearity caused by the dispersion of the optical fiber on the basis of the interference light obtained by the interference between the reference light and the reflected light of the measurement light from the predetermined position, and update the correction parameter stored in the storage unit 162 by the acquired parameter.

In this manner, the imaging apparatus 1 may acquire a parameter for acquiring a tomographic image in a case where the propagation speeds of the measurement light propagated through the first optical path and the reference light are the same on the basis of the interference light acquired on the basis of the reflected light of the measurement light from the predetermined position. Therefore, the imaging apparatus 1 can acquire a tomographic image with higher resolution even in a case where a sweeping speed of the wavelength sweeping light source 11 is not constant.

The adjustment unit 14 may adjust the optical path length so that the photodiode 151 detects the light intensity of the interference light obtained by the interference between the reference light and the reflected light from the predetermined position on the basis of the operation state of the imaging apparatus 1. The signal processing unit 16 may update the correction parameter stored in the storage unit 162 on the basis of the interference light obtained by interference between the reference light and the reflected light from the predetermined position.

In this manner, the imaging apparatus 1 may acquire the correction parameter by using the reflected light from the predetermined position on the basis of the operation state of the imaging apparatus 1. Therefore, the imaging apparatus 1 can acquire a highly useful correction parameter in a state in which the operation of the imaging apparatus 1 is stable and can acquire a tomographic image with higher resolution.

In a case where it is detected that at least either the temperature or the operation time of the imaging apparatus 1 satisfies a predetermined condition as the operation state, the adjustment unit 14 may adjust the optical path length such that the photodiode 151 detects the light intensity of the interference light obtained by the interference between the reflected light from the predetermined position and the reference light.

In this manner, the imaging apparatus 1 may acquire the correction parameter in a case where at least either the temperature or the operation time of the imaging apparatus 1 satisfies a certain condition. Therefore, the imaging apparatus 1 can accurately determine a state in which the operation of the imaging apparatus 1 is stable and acquire a highly useful correction parameter.

In a case where it is detected that at least either the temperature or the operation time of the imaging apparatus 1 satisfies a predetermined condition, the signal processing unit 16 may adjust the optical path length such that the photodiode 151 detects the light intensity of the interference light obtained by the interference between the reflected light from the predetermined position and the reference light in conjunction with the startup operation or the shutdown operation of the imaging apparatus 1.

In this manner, the imaging apparatus 1 may execute processing of acquiring the correction parameter in conjunction with the startup operation or the shutdown operation of the imaging apparatus 1. Therefore, the imaging apparatus 1 can acquire a highly useful correction parameter without hindering the use of the device by the user.

The present disclosure is not limited to the above-described embodiments. For example, a plurality of blocks illustrated in a block diagram may be integrated, or one block may be divided. Instead of being chronologically executed according to the description, a plurality of steps illustrated in the flowchart may be executed in parallel or in a different order, depending on the processing capacity of the apparatus that executes each step or each step as needed. In addition, modifications can be made without departing from the gist of the present disclosure.

The detailed description above describes embodiments of an optical coherence tomographic imaging apparatus. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. An optical coherence tomographic imaging apparatus comprising:
a wavelength sweeping light source configured to output an output light while periodically changing a wavelength;
a light splitter configured to split the output light output from the wavelength sweeping light source into measurement light and reference light;
a photoelectric converter configured to convert light intensity of interference light obtained by interference between the reference light and reflected light of the measurement light with which an object to be measured is irradiated via a first optical path through which the measurement light is propagated from the light splitter to the object to be measured into an electric signal;
a signal processing unit configured to perform arithmetic processing on the electric signal on a basis of a correction parameter stored in a storage unit to acquire a tomographic image of the object to be measured;
a switching unit provided in the first optical path configured to switch a propagation destination of the measurement light between the object to be measured and a second optical path provided with a reflector at one end of the switching unit; and
wherein the signal processing unit is configured to update the correction parameter stored in the storage unit on a basis of interference light obtained by interference between the reference light and reflected light of the measurement light with which the reflector is irradiated via the second optical path in a state in which the measurement light is propagated to the reflector via the second optical path.

2. The optical coherence tomographic imaging apparatus according to claim 1, wherein the signal processing unit is configured to:
acquire a parameter for canceling an influence of a nonlinear change of a wavelength of the output light output from the wavelength sweeping light source with respect to time on a basis of the interference light obtained by interference between the reference light and the reflected light of the measurement light with which the reflector is irradiated via the second optical path; and
update the correction parameter stored in the storage unit with the acquired parameter.

3. The optical coherence tomographic imaging apparatus according to claim 1, wherein the signal processing unit is configured to:
acquire a parameter for canceling an influence of variation by a wavelength in propagation speeds of the measurement light propagated through the first optical path and the reference light on a basis of the interference light obtained by interference between the reference light and the reflected light of the measurement light with which the reflector is irradiated via the second optical path; and
update the correction parameter stored in the storage unit with the acquired parameter.

4. The optical coherence tomographic imaging apparatus according to claim 1, wherein
the switching unit is configured to switch the propagation destination of the measurement light from the object to be measured to the second optical path on a basis of an operation state of the optical coherence tomographic imaging apparatus; and
the signal processing unit is configured to update the correction parameter stored in the storage unit on a basis of the interference light obtained by interference between the reference light and the reflected light of the measurement light with which the reflector is irradiated in a state in which the measurement light is propagated to the reflector via the second optical path.

5. The optical coherence tomographic imaging apparatus according to claim 4, wherein the switching unit is configured to switch the propagation destination of the measurement light from the object to be measured to the second optical path in a case where it is detected that at least either temperature or an operation time of the optical coherence tomographic imaging apparatus satisfies a predetermined condition as the operation state.

6. The optical coherence tomographic imaging apparatus according to claim 5, wherein the switching unit is configured to switch the propagation destination of the measurement light from the object to be measured to the second optical path in conjunction with a startup operation or a shutdown operation of the optical coherence tomographic imaging apparatus in a case where it is detected that at least either the temperature or operation time of the optical coherence tomographic imaging apparatus satisfies a predetermined condition.

7. An optical coherence tomographic imaging apparatus comprising:
a wavelength sweeping light source configured to output an output light while periodically changing a wavelength;
a light splitter configured to split the output light output from the wavelength sweeping light source into measurement light and reference light;
a photoelectric converter configured to convert light intensity of interference light obtained by interference between the reference light and reflected light of the measurement light with which an object to be measured is irradiated via a first optical path through which the measurement light is propagated from the light splitter to the object to be measured into an electric signal;
a signal processing unit configured to perform arithmetic processing on the electric signal on a basis of a correction parameter stored in a storage unit to acquire a tomographic image of the object to be measured;
an adjustment unit configured to adjust an optical path length such that the photoelectric converter detects light intensity of interference light obtained by interference between the reference light and reflected light from a predetermined position determined in advance in the first optical path; and
wherein the signal processing unit is configured to update the correction parameter stored in the storage unit on a basis of the interference light obtained by interference between the reference light and the reflected light from the predetermined position.

8. The optical coherence tomographic imaging apparatus according to claim 7, wherein the signal processing unit is configured to update the correction parameter stored in the storage unit on a basis of the interference light obtained by interference between the reference light and reflected light from a position of a connection surface of different materials in the first optical path or a position of a crack of a material through which the measurement light is propagated in the first optical path as the predetermined position.

9. The optical coherence tomographic imaging apparatus according to claim 7, wherein the signal processing unit is configured to:
acquire a parameter for canceling an influence of a nonlinear change of a wavelength of the output light output from the wavelength sweeping light source with respect to time on a basis of the interference light obtained by interference between the reference light and the reflected light of the measurement light from the predetermined position; and
update the correction parameter stored in the storage unit with the acquired parameter.

10. The optical coherence tomographic imaging apparatus according to claim 7, wherein the signal processing unit is configured to:
acquire a parameter for canceling an influence of variation by a wavelength in propagation speeds of the measurement light propagated through the first optical path and the reference light on a basis of the interference light obtained by interference between the reference light and the reflected light of the measurement light from the predetermined position; and
update the correction parameter stored in the storage unit with the acquired parameter.

11. The optical coherence tomographic imaging apparatus according to claim 7, wherein
the adjustment unit is configured to adjust an optical path length such that the photoelectric converter detects light intensity of the interference light obtained by interference between the reference light and the reflected light from the predetermined position on a basis of an operation state of the optical coherence tomographic imaging apparatus; and
the signal processing unit is configured to update the correction parameter stored in the storage unit on a basis of the interference light obtained by interference between the reference light and the reflected light from the predetermined position.

12. The optical coherence tomographic imaging apparatus according to claim 11, wherein in a case where it is detected that at least either temperature or an operation time of the optical coherence tomographic imaging apparatus satisfies a predetermined condition as the operation state, the adjustment unit adjusts the optical path length such that the photoelectric converter detects light intensity of the interference light obtained by interference between the reference light and the reflected light from the predetermined position.

13. The optical coherence tomographic imaging apparatus according to claim 12, wherein in a case where it is detected that at least either temperature or an operation time of the optical coherence tomographic imaging apparatus satisfies a predetermined condition, the signal processing unit adjusts the optical path length such that the photoelectric converter detects light intensity of the interference light obtained by interference between the reference light and the reflected light from the predetermined position in conjunction with a startup operation or a shutdown operation of the optical coherence tomographic imaging apparatus.

14. A method for improving resolution of an image with an optical coherence tomographic imaging apparatus, the method comprising:
outputting an output light while periodically changing a wavelength with a wavelength sweeping light source;
splitting the output light output from the wavelength sweeping light source into measurement light and reference light with a light splitter;
converting light intensity of interference light obtained by interference between the reference light and reflected light of the measurement light with which an object to be measured is irradiated via a first optical path through which the measurement light is propagated from the light splitter to the object to be measured into an electric signal with a photoelectric converter;
performing arithmetic processing on the electric signal on a basis of a correction parameter stored in a storage unit to acquire a tomographic image of the object to be measured with a signal processing unit;
switching a propagation destination of the measurement light between the object to be measured with a switching unit provided in the first optical path, and a second optical path provided with a reflector at one end of the switching unit; and
updating the correction parameter stored in the storage unit on a basis of interference light obtained by interference between the reference light and reflected light of the measurement light with which the reflector is irradiated via the second optical path in a state in which the measurement light is propagated to the reflector via the second optical path with the signal processing unit.

15. The method according to claim 14, further comprising:
acquiring a parameter with the signal processing unit for canceling an influence of a nonlinear change of a wavelength of the output light output from the wavelength sweeping light source with respect to time on a basis of the interference light obtained by interference between the reference light and the reflected light of the measurement light with which the reflector is irradiated via the second optical path; and
updating the correction parameter stored in the storage unit with the acquired parameter.

16. The method according to claim 14, further comprising:
acquire a parameter with the signal processing unit for canceling an influence of variation by a wavelength in propagation speeds of the measurement light propagated through the first optical path and the reference light on a basis of the interference light obtained by interference between the reference light and the reflected light of the measurement light with which the reflector is irradiated via the second optical path; and
updating the correction parameter stored in the storage unit with the acquired parameter.

17. The method according to claim 14, further comprising:
switching the propagation destination of the measurement light with the switching unit from the object to be measured to the second optical path on a basis of an operation state of the optical coherence tomographic imaging apparatus.

18. The method according to claim 17, further comprising:
updating the correction parameter stored in the storage unit with the signal processing unit on a basis of the interference light obtained by interference between the reference light and the reflected light of the measurement light with which the reflector is irradiated in a state in which the measurement light is propagated to the reflector via the second optical path.

19. The method according to claim 18, further comprising:
switching the propagation destination of the measurement light with the switching unit from the object to be measured to the second optical path in a case where it is detected that at least either temperature or an operation time of the optical coherence tomographic imaging apparatus satisfies a predetermined condition as the operation state.

20. The method according to claim 19, further comprising:
switching the propagation destination of the measurement light with switching unit from the object to be measured to the second optical path in conjunction with a startup operation or a shutdown operation of the optical coherence tomographic imaging apparatus in a case where it is detected that at least either the temperature or operation time of the optical coherence tomographic imaging apparatus satisfies a predetermined condition.
